(19) United States
(12) Patent Application Publication
(10) Pub. No.: US 2015/0363026 A1
(43) Pub. Date: Dec. 17, 2015

(54) CONTROL DEVICE, OPERATION MODE ALTERING METHOD THEREOF, CONTROL METHOD THEREOF AND BATTERY POWER WARNING METHOD THEREOF

(71) Applicant: Touchplus Information Corp., New Taipei City (TW)

(72) Inventors: Shih-Hsien HU, New Taipei (TW); Yi-Feng WEI, New Taipei (TW); Yao-Chih CHUANG, Tainan (TW); Hung-Wang HSU, Taoyuan (TW)

(21) Appl. No.: 14/740,653

(22) Filed: Jun. 16, 2015

(30) Foreign Application Priority Data
Jun. 16, 2014 (TW) 103120750
Jun. 24, 2014 (TW) 103211177

(51) Int. Cl. G06F 3/045; G08C 17/02

(52) U.S. Cl. CPC G06F 3/045; G08C 17/02; G08C 2201/30; G08C 2201/10

(57) ABSTRACT

A control device, operation mode altering method thereof, control method thereof and battery power warning method thereof is provided. The control device comprises a housing structure, a first touch sensing apparatus and a second touch sensing apparatus. The housing structure comprises a surface. The first touch sensing apparatus is disposed in the housing structure and provides a first touch sensing surface for sensing a moving status of a first touching object. The second touch sensing apparatus is disposed in the housing structure and provides a second touch sensing surface for sensing a moving status of a second touching object. The first touch sensing surface and the second touch sensing surface are disposed at different areas of the surface.

### FIELD OF THE INVENTION

The present invention relates to a technique field of control device, and more particularly to a control device, operation mode altering method thereof, control method thereof and battery power warning method thereof.

### BACKGROUND OF THE INVENTION

As a variety of user interfaces in the digital television being developed, a remote controller for controlling the user interfaces must satisfy the requirement of various kinds of instruction input types. However, a conventional remote controller which uses push buttons as its primary input mechanism is not good enough to control a window-based user interface. Therefore, it is important to develop a control device which satisfies the requirement of various kinds of instruction input types.

### SUMMARY OF THE INVENTION

One embodiment of the present invention provides a control device comprising a housing structure, a first touch sensing apparatus and a second touch sensing apparatus. The touch sensing apparatus is disposed in the housing structure and provides a first touch sensing surface for sensing a moving status of a first touching object, and the second touch sensing apparatus is disposed in the housing structure and provides a second touch sensing surface for sensing a moving status of a second touching object, wherein the first touch sensing surface and the second touch sensing surface are disposed at different areas of a surface of the housing structure.

According to the concept above, the first touch sensing surface and the second touch sensing surface can be disposed at two surfaces, which are opposite and are on outside of the housing structure, respectively.

One embodiment of the present invention provides a control method of the control device mentioned above. The control method sets a corresponded instruction corresponding to a touch trace of one of the first touch sensing apparatus and the second touch sensing apparatus, wherein the corresponded instruction comprises at least one of the following functions: fast forward, page change, resize and mouse scroll wheel.

One embodiment of the present invention provides an operation mode altering method of control device, which is adapted to altering an operation mode of a control device with a touch sensing apparatus. The operation mode altering method comprises generating, by the touch sensing apparatus, a touch trace by sensing a moving status of a touching object on the touch sensing apparatus; and determining the operation mode according to the touch trace.

According to the concept above, the step of determining the operation mode according to the touch trace comprises selecting the operation mode from one of a touch scrolling mode and a touch pointer mode.

According to the concept above, when the control device further comprises a push button apparatus, the step of determining the operation mode according to the touch trace comprises determining, according to the touch trace, whether the touch sensing apparatus or the push button apparatus is used to receive an instruction.

According to the concept above, the touch sensing apparatus is determined to receive the instruction when the touch trace represents that the touching object stops for a predetermined time period within a certain area.

According to the concept above, the push button apparatus is determined to receive the instruction when the touch trace represents that the touching object is not detected by the touch sensing apparatus for a predetermined time period.

One embodiment of the present invention provides a battery power warning method of control device, which is adapted to a control device using a battery. The battery power warning method comprises determining whether a remained power of the battery is less than a predetermined amount; and remotely controlling a controlled device to deliver a warning content when the remained power is less than the predetermined amount.

One embodiment of the present invention provides a control device comprising a housing structure, and a first touch sensing apparatus disposed in the housing structure and providing a first touch sensing surface for sensing a moving status of a first touching object, wherein the first touch sensing surface is a smooth surface structure, the first touch sensing apparatus controls a functional circuit by outputting a corresponded instruction to the functional circuit, and the corresponded instruction is generated by the first touch sensing apparatus in accordance with a plurality of capacitance variations generated corresponding to a control gesture made near the first touch sensing surface.

According to the concept above, the functional circuit comprises a plurality of light emitting diode units. Furthermore, the first touch sensing apparatus comprises seven hexagonal sensing electrodes separated from each other, and the capacitance variations are combined to be a three-dimensional data and then converted to the corresponded instruction comprising RGB data.

According to the concept above, the smooth surface structure is a dome structure.

One embodiment of the present invention provides a housing structure, a sensing electrode and a controller. The housing structure is with a surface wherein a first area and a second area are defined on the surface, and the second area surrounds peripheral of the first area. The sensing electrode is disposed below the surface, and generates a first position information and a second position information responding to a touch action in the first area and the second area. The controller is signal connected to the sensing electrode for generating a first control signal according to the first position information and generating a second control signal according to the second position information, wherein the first control signal is used for controlling an indicator to move at a first resolution, the second control signal is used for controlling the indicator to move at a second resolution, and the first resolution is greater than the second resolution.

According to the concept above, the sensing electrode comprises a center sensing pad and a plurality of peripheral sensing pad sets, wherein the center sensing pad and a first part of the peripheral sensing pad sets are disposed below the first area, and a second part of the peripheral sensing pad sets are disposed below the second area. Furthermore, a distance between each of the peripheral sensing pad sets and a center point of the center sensing pad is the same as others.

According to the concept above, the second position information is a polar coordinate information, and a direction in which the indicator moves at the second resolution is controlled by the second control signal determined according to an angle of the polar coordinate information.

According to the concept above, a moving speed of the indicator controlled by the second control signal is determined according to length of a time period during which the touch action is detected by the sensing electrode.

According to the concept above, the sensing electrode is covered by a push button housing material.

According to the concept above, the sensing electrode is disposed between a plurality of push buttons of a keyboard, and is covered by a housing material which forms an upper case of the keyboard or integrated into a circuit board under the push buttons.

The control device provided by the present invention makes user easier control a plurality of input interfaces. Besides this, it is easy to altering operation modes so that the control device could be used in circumstances with different kinds of input requirements. Furthermore, the function of battery power warning makes users know when to replace the batteries for keeping normal operation of the control device.

### BRIEF DESCRIPTION OF THE DRAWINGS

The present invention will become more readily apparent to those ordinarily skilled in the art after reviewing the following detailed description and accompanying drawings, in which:

FIG. 1A is a circuitry block diagram of a control device according to one embodiment of the present invention.

FIG. 1B is a circuitry block diagram of a control device according to one embodiment of the present invention.

FIG. 1C is a schematic diagram showing positions of electronic elements of a control device according to one embodiment of the present invention.

FIG. 1D is a schematic diagram showing positions of electronic elements of a control device according to one embodiment of the present invention.

FIG. 2A is a schematic diagram showing appearance of a control device according to one embodiment of the present invention.

FIG. 2B is a schematic diagram showing appearance of lateral view of a control device according to one embodiment of the present invention.

FIG. 2C is a schematic diagram showing appearance of lateral view from another side of the control device shown in FIG. 2B.

FIG. 2D is a schematic diagram showing appearance of a control device according to one embodiment of the present invention.

FIG. 2E is a schematic diagram showing a plurality of sensing electrodes according to one embodiment of the present invention.

FIG. 2F is a schematic diagram of a control device according to one embodiment of the present invention.

FIG. 3A is a flow chart of an operation mode altering method of control device according to one embodiment of the present invention.

FIG. 3B is a flow chart of an operation mode altering method of control device according to one embodiment of the present invention.

FIG. 4 is a flow chart of a battery power warning method according to one embodiment of the present invention.

FIG. 5 is a schematic diagram of a control device according to one embodiment of the present invention.

FIG. 6 is a schematic diagram of sensing electrodes in FIG. 5 according to one embodiment of the present invention.

FIG. 7 is a schematic diagram showing a keyboard integrated with a control device according to one embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

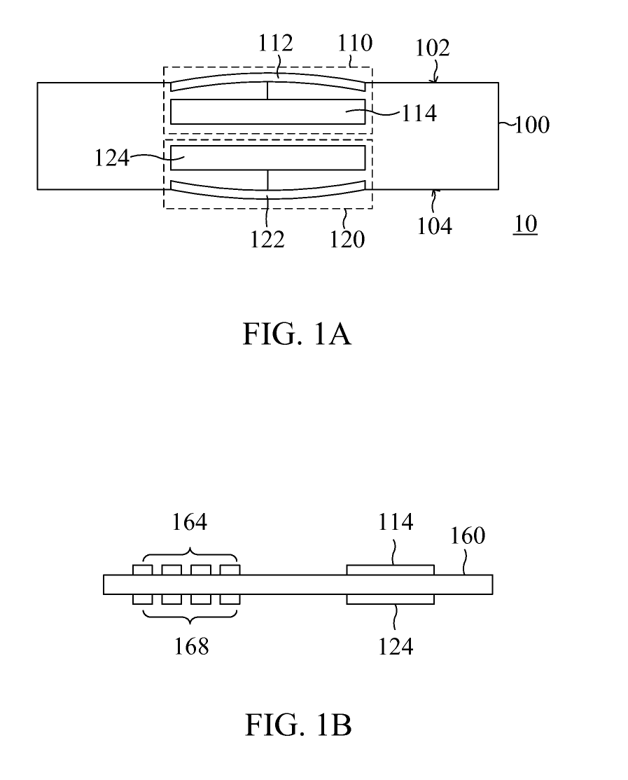

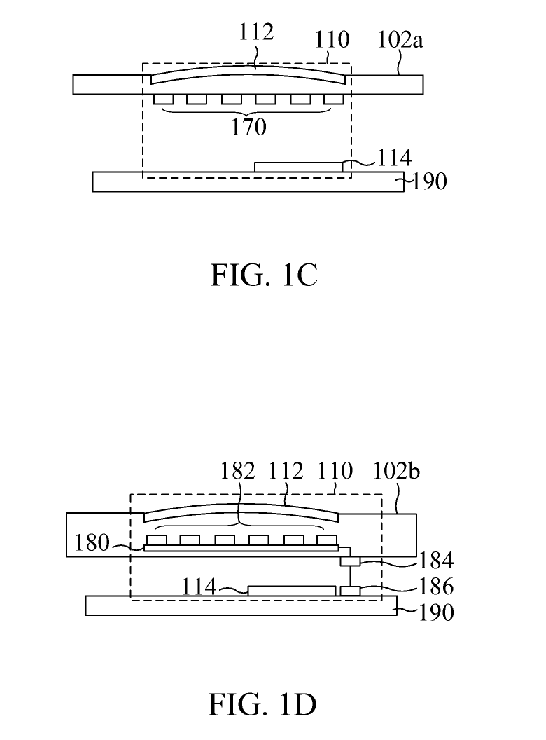

Please refer to FIG. 1A, which is a circuitry block diagram of a control device according to one embodiment of the present invention. In the embodiment, a control device 10 comprises a housing structure 100, a touch sensing apparatus 110 and a touch sensing apparatus 120, wherein the touch sensing apparatuses 110 and 120 are disposed in the housing structure 100. The touch sensing apparatus 110 comprises a touch sensing surface 112 and a signal processing unit 114. The touch sensing surface 112 is disposed on a surface 102 of the housing structure 100 for sensing a moving status of a touching object, and generates a corresponded electronic signal according to the moving status. The electronic signal generated from the touch sensing surface 112 is transmitted to the signal processing unit 114, and then is processed by the signal processing unit 114 to generate a corresponding data for representing the sensed moving status of the touching object. The data which is formed by accumulating the corresponding data generated by the signal processing unit 114 during a time period is defined to be a touch trace of the touching object sensed by the touch sensing surface 112.

Similarly, the touch sensing apparatus 120 comprises a touch sensing surface 122 and a signal processing unit 124. The touch sensing surface 122 is disposed on a surface 104 of the housing structure 100 for sensing a moving status of a touching object, and generates a corresponded electronic signal according to the moving status. The electronic signal generated from the touch sensing surface 122 is transmitted to the signal processing unit 124, and then is processed by the signal processing unit 124 to generate a corresponding data for representing the sensed moving status of the touching object. The data which is formed by accumulating the corresponding data generated by the signal processing unit 124 during a time period is defined to be a touch trace of the touching object sensed by the touch sensing surface 122.

In the embodiment, the control device 10 comprises two touch sensing apparatuses 110 and 120 simultaneously, and the touch sensing surface 112 of the touch sensing apparatus 110 and the touch sensing surface 122 of the touch sensing apparatus 120 are on opposite surfaces 102 and 104 of the housing structure 100, respectively. It is noted that, although the touch sensing surfaces 112 and 122 are on opposite surfaces 102 and 104 of the housing structure 100 in this embodiment, normal operation of the touch sensing apparatuses 110 and 112 can be completed by providing individual sensing areas for the touch sensing surfaces 112 and 122, respectively. That is, the touch sensing surfaces 112 and 122 can be on different surfaces of the housing structure 100, or the touch sensing surfaces 112 and 122 can be on different areas on the same surface of the housing structure 100. Furthermore, the touch sensing surfaces 112 and 122 are not necessary to slightly protruded from the surfaces 102 and 104. The position relationship between the surfaces and the touch sensing surfaces thereon can be freely adjusted on the premise that the touch sensing surfaces can properly detecting whether a touch object exists or not.

Moreover, different touch sensing apparatus could be preset to different usages. For example, the touch sensing apparatus 110 could be set to function as a normal mouse, i.e. the same function as the touch pad manufactured on a notebook, while the touch sensing apparatus 120 could be set to perform specific instructions, such as fast forward, page change, resize and mouse scroll wheel when predefined specific touch traces are detected. That is, it can be set that a continuous tapping on the touch sensing apparatus 120 means page change function, and a left/right sliding on the touch sensing apparatus 120 means frame fast forward/backward, etc. It is noted that the usages of the two touch sensing apparatuses 110 and 120 can be exchanged and not limited to the method mentioned above.

Accordingly, a touch sensing surface should comprises a surface to be touched by one object which is going to be sensed by corresponded touch sensing apparatus, and a sensing electrode which senses physical variations (such as capacitance variation) caused by the sensed object. Please refer to FIG. 1A and FIG. 1B, wherein FIG. 1B is a circuitry block diagram of a control device according to one embodiment of the present invention. As shown in the figures, an electronic signal insulating layer 160, such as a metal plate or printed circuit board, which is capable of blocking transmitting of electronic signals, is provided between the two touch sensing apparatuses 110 and 120 in order to prevent the touch sensing apparatuses 110 and 120 from being interfered with each other. Assuming that the sensing electrode 164 is comprised in the touch sensing surface 112 and the sensing electrode 168 is comprised in the touch sensing surface 122, the physical variations caused by the object near the touch sensing surface 112 can only be sensed by the sensing electrode 164 and not be sensed by the sensing electrode 168 due to existence of the electronic signal insulating layer 160. For the same reason, the physical variations caused by the object near the touch sensing surface 122 can only be sensed by the sensing electrode 168 and not sensed by the sensing electrode 164 due to existence of the electronic signal insulating layer 160.

The sensing electrode 164 can be accomplished by etching the single metal layer or multi metal layer on a printed circuit board for defining a shape of the sensing electrode 164, and an external plane, which might be contacted with the object going to be sensed, of the touch sensing surface 112 or 122 is accomplished by covering a cladding above the etched metal layer. The covering process can be accomplished by using a mold or injection molding process.

Please refer to FIG. 1C, which is a schematic diagram showing positions of electronic elements of a control device according to one embodiment of the present invention. In this figure, only the electronic elements of the touch sensing apparatus 110 in FIG. 1A is illustrated, and, if there exists other touch sensing apparatus, the electronic elements of other touch sensing apparatus can be arranged in the similar way or in any other ways. As shown in FIG. 1C, the signal processing unit 114 is disposed on the substrate 190, and the sensing electrodes 170 is disposed on the surface, which is opposite to the substrate 190, of the side housing structure 102a. In another aspect, the signal processing unit 114 and the sensing electrodes 170 are both within the housing structure 100 shown in FIG. 1A, and they are located at the same side of the substrate 190. Besides this, the signal processing unit 114 and the sensing electrodes 170 are firmly disposed on different bearers. It is noted that, although the signal processing unit 114 is firmly disposed on the substrate 190 and the sensing electrodes 170 are firmly disposed on the side housing structure 102a in this embodiment, it is not the only way to arrange these electronic elements. For example, the sensing electrodes 170 could be disposed on another substrate, the substrate with the sensing electrodes 170 could be disposed between the side housing structure 102a and the substrate 190, and the sensing electrodes 170 are further arranged to face the surface of the side housing structure 102a so that the object can be sensed by the touch sensing surface 112.

Please refer to FIG. 1D, which is a schematic diagram showing positions of electronic elements of a control device according to one embodiment of the present invention. Similarly, only the electronic elements of the touch sensing apparatus 110 in FIG. 1A is illustrated, and, if there exists other touch sensing apparatus, the electronic elements of other touch sensing apparatus can be arranged in the similar way or in any other ways.

As shown in this figure, the signal processing unit 114 is disposed on the substrate 190, the sensing electrodes 182 are disposed on the substrate 180, and the sensing electrodes 182 and the substrate 180 are both within the side housing structure 102b. The physical variation sensed by the sensing electrodes 182 is converted to the electronic signal and transmitted to the transmission port 184 at the side housing structure 102b through the circuitry layout and related traces in the substrate 180. The transmitted electronic signal is then transmitted to the transmission port 186 from the transmission port 184 through the transmission lines, and is then provided to the signal processing unit 114 for processing. It is noted that, although the sensing electrodes 182 are disposed on the substrate 180, this is not the only way to arrange the sensing electrodes 182. For example, the sensing electrode 182 can be directly disposed on the inner surface of the side housing structure 102b, and the sensing electrodes 182 are arranged to face the surface of the side housing structure 102b so that the object can be sensed by the touch sensing surface 112.

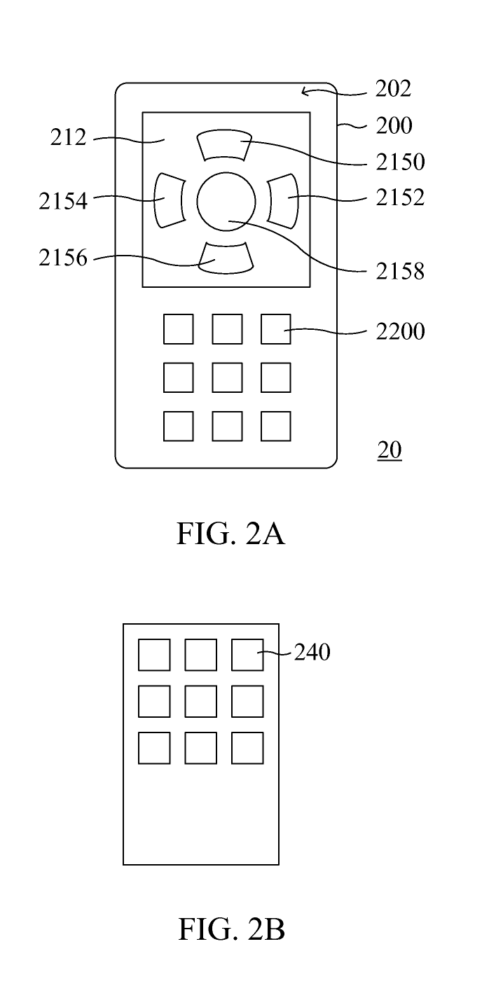

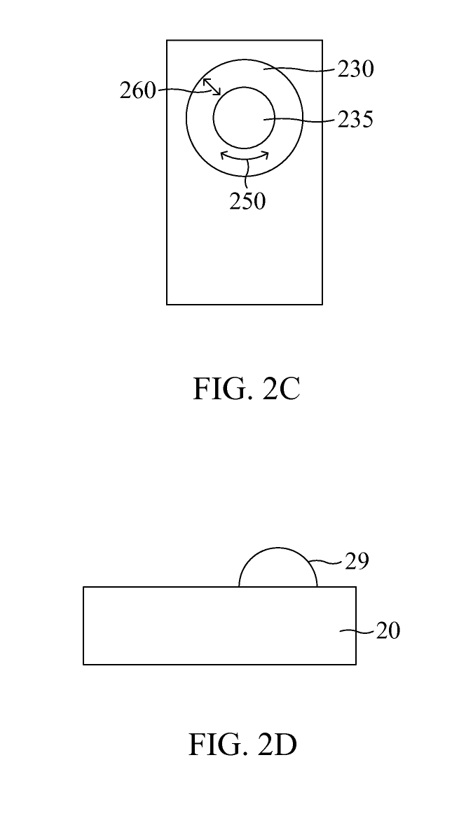

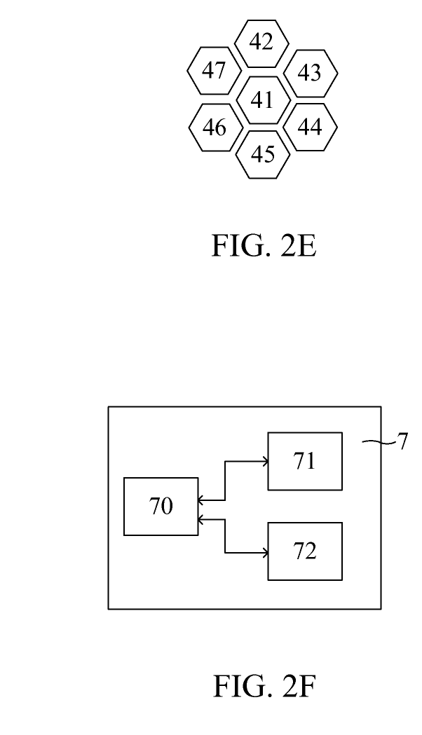

Please refer to FIG. 2A, which is a schematic diagram showing appearance of a control device according to one embodiment of the present invention. In this embodiment, the control device 20 is primarily applied to control a graphical user interface. The usual appearance of the control device 20 is the wired/wireless control device used in an image displaying system, such as a television system, a computer system, an optic disc player system, a set-top box system or intellectual display system, and the graphical user interface is the graphic operation interface output and displayed by the image displaying system. The control device 20 primarily comprises a housing structure 200 to cover the electronic circuit elements therein (for example, the touch sensing apparatus 110 and 120 in FIG. 1A-1D, not shown in this figure). A touch sensing surface 212, which functions similar to the touch sensing surface 112 in the embodiment shown in FIG. 1A, is disposed on the surface 202 of the housing structure 200.

Furthermore, the control device 20 further comprises a push button apparatus having a plurality of push buttons, such as push button 2150, 2152, 2154, 2156, 2158 and 2200. These push buttons 2150˜2200 are exposed from the surface 202 of the housing structure 200 and compose the push button apparatus. The push button apparatus is primarily used for sending a control instruction related to the graphical user interface and generating height difference relative to the surface of the housing structure in responding to push actions made thereon by users. For example, the push buttons 2150˜2156 in the present embodiment could be set as arrow keys while the push button 2158 is set as confirm key, so that users may adjust a plurality of parameters in the graphical user interface and confirm the selected result by pushing the push buttons 2150˜2158.

Moreover, in this embodiment, the push buttons 2150˜2158 are disposed above a touch sensing apparatus (not shown in this figure) and is integrated with the touch sensing surface 212, that is, the surfaces of the push buttons 2150˜2158 are at a plane or arc the same as the touch sensing surface 212 when the push buttons 2150˜2158 are not pushed, or the surface of the push buttons 2150˜2158 are slightly higher than the touch sensing surface 212 when the push buttons 2150˜2158 are not pushed. In such a way, the touch sensing apparatus can sense the touch trace on the surfaces of the push buttons 2150˜2158 made by users and generate the control instruction related to the graphical user interface. For example, when a finger slides on or at a short distance above the surface of the push buttons 2150˜2158, the touch sensing apparatus could sense the touch trace and send out the control signal to control an indicator in the graphical user interface correspondingly.

Please refer to FIGS. 2B and 2C, wherein FIG. 2B is a schematic diagram showing appearance of lateral view of a control device according to one embodiment of the present invention, and FIG. 2C is a schematic diagram showing appearance of lateral view from another side of the control device shown in FIG. 2B. In the embodiment shown in FIG. 2B and FIG. 2C, the front side of the control device is only provided with normal push buttons 240, and the back side of the control device is provided with a touch sensing surface 230. A center sensing area 235 exists in the touch sensing surface 230. During operating, the moving status of staying the object within the center sensing area 235 or moving the object within the center sensing area 235 is determined to be stationary. On the contrary, when the moving status of the object is to move within the area defined by the touch sensing area 230 and outside the center sensing area 235, the operation is classified by moving styles, such as moving in arc way 250 or moving in radial way 260, and defined as different specific instruction correspondingly.

Since the operation at one position may be made for operating the push button apparatus or operating the touch sensing apparatus, there should exist a mechanism for confirming which apparatus is the one the operation would like to operate. Or, in other words, there should exist an operation mode altering method, which can switches the operation mode of the control device between a push button apparatus operation mode and a touch sensing apparatus operation mode, of the control device.

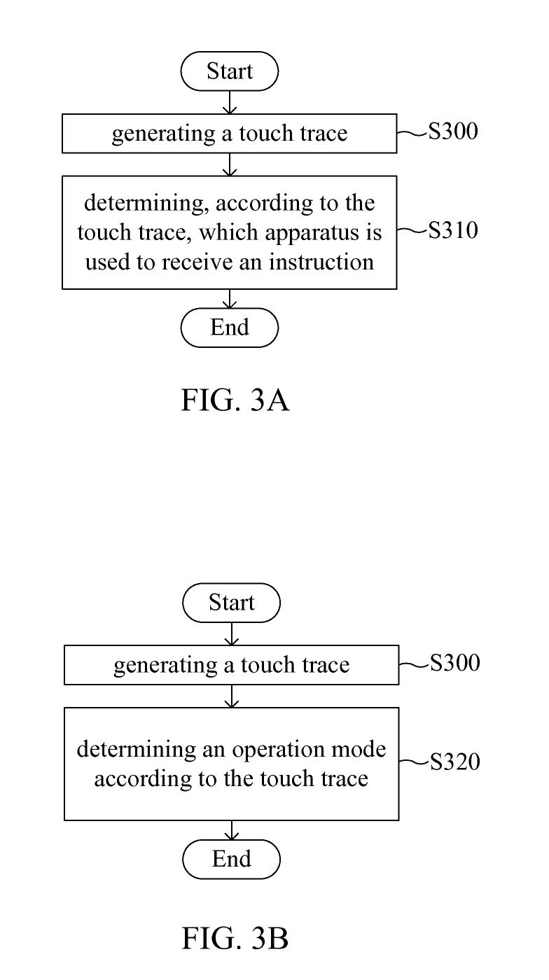

Please refer to FIG. 3A, which is a flow chart of an operation mode altering method of control device according to one embodiment of the present invention. In this embodiment, a touch trace is generated by the touch sensing apparatus by sensing a moving status of a touching object on the touch sensing apparatus (Step S300); and then the touch trace is applied for determining whether the touch sensing apparatus or the push button apparatus is used to receive an instruction (Step S310).

For example, it could be determined to use the touch sensing apparatus to receive the instruction when the touch trace represents that the touching object stops for a first predetermined time period within a certain area, or it could be determined to use the push button apparatus to receive the instruction when the touch trace represents that the touching object is not detected by the touch sensing apparatus for a second predetermined time period. Specifically, when the control device 20 shown in FIG. 2A is accompanied with the operation mode altering method disclosed in FIG. 3, the operation mode would be changed to the touch sensing apparatus operation mode and the touch sensing apparatus is used to receive instructions (i.e., gesture operation) input thereafter if an object stays at the place within the range of the push button 2158 for a time period (for example, 3 seconds). In another aspect, if the control device 20 is in the touch sensing operation mode, the control device 20 will be changed to the push button apparatus operation mode and the push button apparatus is used to receive instructions (i.e., pushing status of the push buttons) input thereafter if there's no object being sensed during a time period (for example, 5 seconds).

Specifically, when the touch sensing surface 212 in FIG. 2A is substituted by the touch sensing surface 230 in FIG. 2C and the position of the center sensing area 235 is matched with the position of the push button 2158, the control device would determine the touching object is stationary even the touching object is slightly moves on the push button 2158. By applying this modification, the drawback of selecting wrong items due to finger or touching object trembling can be effectively improved.

Accordingly, users can input instructions by using touch sensing apparatus after keeping the touching object (such as finger) in a certain area for a certain time period. At the same time, users can input instructions by using push button apparatus after keeping the touching object away from the touch sensing surface for a certain time period. It is noted that, there are many other ways to switch the control device between different operation modes, such as switching a switch, making a specific touch trace (for example, drawing a pentagram), or continuously tapping for a certain times, etc.

In another aspect, as shown in FIG. 3B, after obtaining the touch trace in step S300, the touch trace can be applied for selecting one of a plurality of operation modes of the touch sensing apparatus (S320). For example, when the touch sensing apparatus supports a plurality of operation modes, such as a touch scrolling mode and a touch pointer mode, the touch scrolling mode of the touch sensing apparatus is selected after keeping the touching object (such as finger) in a certain area for a certain time period, and the touch pointer mode of the touch sensing apparatus is selected after continuously tapping the touch sensing apparatus for a certain times.

Moreover, the touch sensing surface 212 can be accomplished by using a smooth surface structure in dome structure 29 without any push buttons as shown in FIG. 2D. Accordingly, the control device can be used for controlling the functional circuits such as a light source comprising light emitting diodes of three primary colors. It is noted that the smooth surface structure can be replaced by a shape of projection, flat, concave or those conform to ergonomics.

Please refer to FIG. 2E, which is a schematic diagram showing a plurality of sensing electrodes according to one embodiment of the present invention. The sensing electrodes 41, 42, 43, 44, 45, 46 and 47 are arranged by seven hexagons which are separated from each other. Every two neighbored sensing electrodes are grouped into one sensing group. Taking difference between a sum of the capacitance values sensed by one sensing group and the sum of the capacitance values sensed by another one sensing group neighbored to the selected one sensing group, a pre-data is obtained. After calculating capacitance value difference between any two neighbored sensing groups, total twelve pre-data could be obtained. Three calculated data can be formed by processing the twelve pre-data in a suitable way, and then the three calculated data are used to represent the three primary colors. In other words, touching status generated by a palm or fingers of a user or other touching objects can be summarized into a three-dimensional data by using these sensing electrodes, and the signal processing unit 114 or 124 generates a corresponded instruction according to the three-dimensional data and transmits the corresponded instruction to the functional circuit (not shown) accomplished by the light emitting diodes of three primary colors so as to control the brightness and color of the functional circuit. Beside this, the touching trail and the coordinate of the touched point detected by the sensing electrodes could be used to input instructions to the graphical user interface, for example, to control an indicator, switch pages or change distance of z-axis on a functional circuit with display.

Please refer to FIG. 2F, which is a schematic diagram of a control device according to one embodiment of the present invention. In this embodiment, the control device 7 further comprises an audio apparatus 70 and an attitude sensor 71 to form an audio playing apparatus such as phone speaker, mobile phone, earphone, etc. Therefore, besides sensing gestures of the users by using the touch sensing apparatus 72, the control device 7 in the present invention can further sense the attitude of the control device 7 by using the attitude sensor 71 (such as G-sensor) so as to change the operation mode of the control device according to the attitude of the control device 7. Take the mobile phone as an example, when the attitude sensor 71 detects that the control device 7 is horizontally placed, the mobile phone is determined to be placed on a desk so that the mobile phone is operated in a public-address mode. However, when the attitude sensor 71 detects that the control device 7 is held, the mobile phone is operated in a hand-held mode. When the control device 7 is in the public-address mode, the audio volume and the microphone sensitivity is adjusted to a first intensity range, and when the control device 7 is in the hand-held mode, the audio volume and the microphone sensitivity is adjusted to a second intensity range, wherein the second intensity range is within the first intensity range and is a weaker intensity part of the first intensity range. For the same reason, the attitude sensing result can be used to switch a directivity characteristic of sound, a sound field shape, a sound quality or a distribution of high/bass sound, so that the control device 7 is operated at a setting adapted to the public-address mode or hand-held mode. It is noted that, the touch control function of the touch sensing apparatus 72 can be used to adjusting the sound volume and quality.

Furthermore, the control device 7 could be used to accomplish toys or musical instruments with sound/light effect, wherein the tone, volume and pitch generated by the toys or musical instruments are controlled by the attitude sensing result.

However, because the touch sensing apparatus nowadays determines whether a touching object is exist by analyzing voltage variation amplitudes, a reference voltage which is stable enough during operation is very important. This is why the touch sensing apparatuses nowadays are designed for an environment having stable power sources. However, it is general to apply little and light batteries in a control device. Therefore, the stability of the battery power is a key point of stability of the touch sensing device.

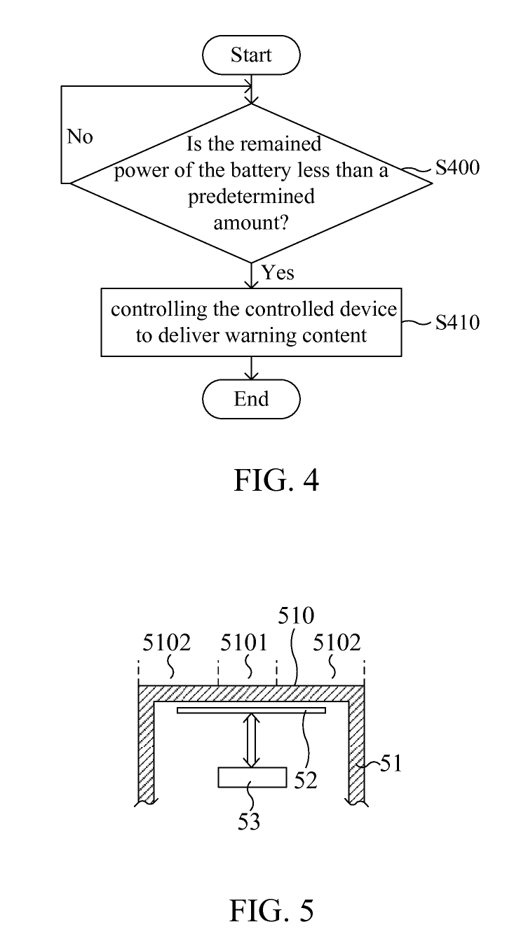

Please refer to FIG. 4, which is a flow chart of a battery power warning method according to one embodiment of the present invention. In the embodiment, the step S400 determines whether a remained power of the battery is less than a predetermined amount. If the remained power is not less than the predetermined amount, no other operation is performed and the flow goes back to step S400. On the contrary, the flow goes to step S410 for remotely controlling a controlled device to deliver a warning content when the remained power is less than the predetermined amount.

For example, when applying the method in the embodiment to a television remote controller, the television is the controlled device mentioned above. Accordingly, once the remained power of the battery in the television remote controller is too low, the television remote controller will control the television to deliver a warning content. The warning content could be a repeatedly performed specific function of the television, such as displaying menu. In order to make the control device be adapted to the controlled devices of different brands, the warning content selected should be the functions provided by most controlled devices.

Please refer to FIG. 5, which is a schematic diagram of a control device according to one embodiment of the present invention. The control device in the embodiment primarily comprises a housing structure 51, a sensing electrode 52 and a controller 53. The housing structure 51 is with a surface 510, wherein a first area 5101 and a second area 5102 are defined on the surface 510, and the second area 5102 surrounds peripheral of the first area 5101. The sensing electrode 52 is disposed below the housing structure 51 or integrated into the materials of the housing structure 51, and generates a first position information and a second position information, which is represented by capacitance variation, responding to a touch action in the first area 5101 and the second area 5102. The controller 53, which is signal connected to the sensing electrode 52, is for generating a first control signal according to the first position information and generating a second control signal according to the second position information, wherein the first control signal is used for controlling an indicator to move at a first resolution, the second control signal is used for controlling the indicator to move at a second resolution, and the first resolution is greater than the second resolution.

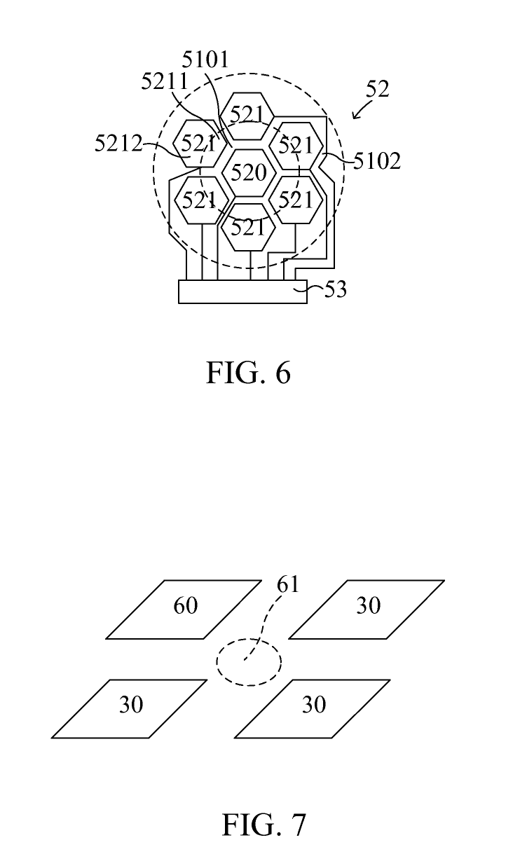

Please refer to FIG. 6, which is a schematic diagram of sensing electrode in FIG. 5 according to one embodiment of the present invention. In the embodiment, the sensing electrode 52 comprises a center sensing pad 520 and a plurality of peripheral sensing pad sets 521, wherein the center sensing pad 520 and a first part 5211 of the peripheral sensing pad sets 521 are below the first area 5101, and a second part 5212 of the peripheral sensing pad sets 521 are below the second area 5102. When fingers or other touching objects are disposed above the housing structure 510, the sensing electrode 52 generates capacitance variation because the fingers or other touching objects come closer. Therefore, the controller 53 can estimate the position information of the fingers or other touching objects in accordance with the capacitance variation. In this embodiment, the controller 53 adjusts the moving style of the indicator according to the relationship between the position information and the first area 5101 and the relationship between the position information and the second area 5102.

When the fingers or other touching objects are determined to be within the first area 5101, the controller 53 processes the capacitance variation of the peripheral sensing pad sets 521 and the center sensing pad 520 to obtain the first position information, which is in the format of two dimensional coordinate, with two dimensional coordinate (X, Y), and the coordinate is used to control the indicator to slowly move at a high resolution in an area on the displayer.

When the fingers or other touching objects are determined to be within the second area 5101, the controller 53 processes the capacitance variation of the peripheral sensing pad sets 521 and the center sensing pad 520 to obtain a polar dimensional coordinate (X, Y). Because a distance between each of the peripheral sensing pad sets 521 and a center point of the center sensing pad 520 is the same as others, the center sensing pad 520 is used to be the original point of the polar coordinate and the second position information, which is in the format of polar coordinate, can be obtained by using position relationship between the peripheral sensing pad sets 521 and the center sensing pad 520. The controller 53 controls the indicator to quickly move at a lower resolution on the display following a direction determined according to an angle of the polar coordinate information, and moving speed of the indicator is proportional to length of a time period during which the fingers or other touching objects are disposed on a certain position in the second area 5102.

In other words, when the user put fingers or other touching objects on the second area 5102 of the surface 510, the controller 53 of the present invention obtains an angle relating to the center point of the center sensing pad 520, and therefore the controller 53 generates a second control signal in responding to the angle so as to control the indicator in the graphical user interface to move with higher speed and lower resolution, wherein the direction of the movement is determined according to the length of the time period during which the touch action lasts. After the indicator quickly moves close to the target, the user touches within the first area 5101 to perform a move in a small range and with high resolution so that the user can select the target quickly and precisely.

Please refer to FIG. 7, which is a schematic diagram showing a keyboard integrated with a control device according to one embodiment of the present invention. The control device is disposed in the area 61 between a plurality of push buttons 60, where is, for example, the position that forefinger usually puts. The only thing has to do is to integrate the sensing electrode 52 into the circuit board under the push buttons or into a housing material which forms an upper case of the keyboard. Not any movable mechanism has to be disposed thereon. The controller 53 can be disposed, either separately or integrated with the keyboard controller, on the circuit board of the keyboard. In another aspect, the control device can be integrated into a push button housing material, where is, for example, the position that forefinger usually puts, such that the sensing electrode is covered by the push button housing material. The only thing has to do is to integrate the sensing electrode 52 into the push button housing material. Not any movable mechanism has to be disposed thereon. At the same time, the controller could also be covered by the push button housing material, or could be disposed, either separately or integrated with the keyboard controller, on the circuit board of the keyboard.

In summary, the control device provided by the present invention makes user easier control a plurality of input interfaces. Besides this, it is easy to altering operation modes so that the control device could be used in circumstances with different kinds of input requirements. Furthermore, the function of battery power warning makes users know when to replace the batteries for keeping normal operation of the control device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operation mode altering method of control device, which is adapted to altering an operation mode of a control device with a touch sensing apparatus, comprising:
generating, by the touch sensing apparatus, a touch trace by sensing a moving status of a touching object on the touch sensing apparatus; and
determining the operation mode according to the touch trace.

2. The operation mode altering method of control device according to claim 1, wherein determining the operation mode according to the touch trace comprises selecting the operation mode from one of a touch scrolling mode and a touch pointer mode.

3. The operation mode altering method of control device according to claim 1, wherein the control device further comprises a push button apparatus, and determining the operation mode according to the touch trace comprises:
determining, according to the touch trace, whether the touch sensing apparatus or the push button apparatus is used to receive an instruction.

4. The operation mode altering method of control device according to claim 3, wherein determining, according to the touch trace, whether the touch sensing apparatus or the push button apparatus is used to receive the instruction comprises:
determining to use the touch sensing apparatus to receive the instruction when the touch trace represents that the touching object stops for a predetermined time period within a certain area.

5. The operation mode altering method of control device according to claim 3, wherein determining, according to the touch trace, whether the touch sensing apparatus or the push button apparatus is used to receive the instruction comprises:
determining to use the push button apparatus to receive the instruction when the touch trace represents that the touching object is not detected by the touch sensing apparatus for a predetermined time period.

6. A control device, comprising:
a housing structure comprising a surface;
a first touch sensing apparatus disposed in the housing structure and providing a first touch sensing surface for sensing a moving status of a first touching object; and
a second touch sensing apparatus disposed in the housing structure and providing a second touch sensing surface for sensing a moving status of a second touching object;
wherein, the first touch sensing surface and the second touch sensing surface are disposed at different areas of the surface.

7. The control device according to claim 6, wherein the first touch sensing surface and the second touch sensing surface are disposed at two surfaces, which are opposite and are on outside of the housing structure, respectively.

8. A battery power warning method of control device, which is adapted to a control device using a battery, comprising:
determining whether a remained power of the battery is less than a predetermined amount; and
remotely controlling a controlled device to deliver a warning content when the remained power is less than the predetermined amount.

9. The battery power warning method of control device according to claim 8, wherein remotely controlling the controlled device to deliver the warning content comprising:
controlling the controlled device to repeatedly perform a specific function.

10. The battery power warning method of control device according to claim 9, wherein the specific function is displaying menu.

11. A control method adapted to the control device as claimed in claim 6, comprising:
setting a corresponded instruction corresponding to a touch trace of one of the first touch sensing apparatus and the second touch sensing apparatus,
wherein the corresponded instruction comprises at least one of the following functions: fast forward, page change, resize and mouse scroll wheel.

12. A control device, comprising:
a housing structure; and
a first touch sensing apparatus disposed in the housing structure and providing a first touch sensing surface for sensing a moving status of a first touching object;
wherein, the first touch sensing surface is a smooth surface structure, and the first touch sensing apparatus controls a functional circuit by outputting a corresponded instruction to the functional circuit, wherein the corresponded instruction is generated by the first touch sensing apparatus in accordance with a plurality of capacitance variations generated corresponding to a control gesture made near the first touch sensing surface.

13. The control device according to claim 12, wherein the functional circuit comprises a plurality of light emitting diode units.

14. The control device according to claim 13, wherein the first touch sensing apparatus comprises seven hexagonal sensing electrodes separated from each other.

15. The control device according to claim 14, wherein the capacitance variations are combined to be a three-dimensional data and then converted to the corresponded instruction comprising RGB data.

16. The control device according to claim 10, wherein the smooth surface structure is a dome structure.

17. A control device, comprising:
a housing structure with a surface, wherein a first area and a second area are defined on the surface, and the second area surrounds peripheral of the first area;
a sensing electrode disposed below the surface and generating a first position information and a second position information responding to a touch action in the first area and the second area; and
a controller, which is signal connected to the sensing electrode, for generating a first control signal according to the first position information and generating a second control signal according to the second position information, wherein the first control signal is used for controlling an indicator to move at a first resolution, the second control signal is used for controlling the indicator to move at a second resolution, and the first resolution is greater than the second resolution.

18. The control device according to claim 17, wherein the sensing electrode comprises a center sensing pad and a plurality of peripheral sensing pad sets, wherein the center sensing pad and a first part of the peripheral sensing pad sets are below the first area, and a second part of the peripheral sensing pad sets are below the second area.

19. The control device according to claim 18, wherein a distance between each of the peripheral sensing pad sets and a center point of the center sensing pad is the same as others.

20. The control device according to claim 17, wherein the second position information is a polar coordinate information, and a direction in which the indicator moves at the second resolution is controlled by the second control signal determined according to an angle of the polar coordinate information.

21. The control device according to claim 17, wherein a moving speed of the indicator controlled by the second control signal is determined according to length of a time period during which the touch action is detected by the sensing electrode.

22. The control device according to claim 17, wherein the sensing electrode is covered by a push button housing material.

23. The control device according to claim 17, wherein the sensing electrode is disposed between a plurality of push buttons of a keyboard, and is covered by a housing material which forms an upper case of the keyboard or integrated into a circuit board under the push buttons.
